(19) United States
(12) Patent Application Publication
(10) Pub. No.: US 2026/0200250 A1
(43) Pub. Date: Jul. 16, 2026

(54) PRINTING APPARATUS AND PRINTING METHOD

(71) Applicant: SEIKO EPSON CORPORATION, Tokyo (JP)

(72) Inventor: Keisuke MUTA, Matsumoto (JP)

(21) Appl. No.: 19/443,086

(22) Filed: Jan. 8, 2026

(30) Foreign Application Priority Data
Jan. 10, 2025 (JP) 2025-003944

(51) Int. Cl. B41J 13/00; B41J 13/08; G06F 3/12

(52) U.S. Cl. CPC B41J 13/0027; B41J 13/08; G06F 3/1205; G06F 3/1254

(57) ABSTRACT

A printing apparatus includes a transport unit configured to transport print media by feeding the print media at a given interval onto a transport belt and rotating the transport belt, a print head configured to eject ink onto the print media on the transport belt, and a controller configured to control the print head and the transport unit based on one or more print jobs to perform printing on the print media. The controller is configured to, for one of the one or more print jobs, when the number of pages is one, feed the print media for a first page before generation of print data of the first page is completed, and when the number of pages is two or more, feed the print media for the first page in response to completion of generation of the print data of the first page.

The present application is based on, and claims priority from JP Application Serial Number 2025-003944, filed January 10, 2025, the disclosure of which is hereby incorporated by reference herein in its entirety.

### BACKGROUND

### 1. Technical Field

The present disclosure relates to a printing apparatus and a printing method.

### 2. Related Art

As disclosed in JP-A-5-286608, a technique is known in which paper-sheet feeding is initiated before completion of first-page print data generation (hereinafter referred to as "pre-feeding") to prevent prolongation of the printing time.

In a configuration in which print media are transported by a rotating transport belt, once printing on one sheet of print media starts, the transport belt continues to rotate. Therefore, simply performing pre-feeding may rather result in a prolonged total printing time.

### SUMMARY

According to an aspect of the present disclosure, a printing apparatus includes a transport unit configured to transport print media by feeding the print media at a given interval onto a transport belt and rotating the transport belt, a print head configured to eject ink onto the print media on the transport belt, and a controller configured to control the print head and the transport unit based on one or more print jobs to perform printing on the print media. The controller is configured to, for one of the one or more print jobs, when the number of pages is one, feed the print media for a first page before generation of print data of the first page is completed, and when the number of pages is two or more, feed the print media for the first page in response to completion of generation of the print data of the first page.

According to another aspect of the disclosure, a printing method is executed by a controller of a printing apparatus that includes a transport unit configured to transport print media by feeding the print media at a given interval onto a transport belt and rotating the transport belt, a print head configured to eject ink onto the print media on the transport belt, and the controller configured to control the print head and the transport unit based on one or more print jobs to perform printing on the print media. The printing method includes, for one of the one or more print jobs, when a number of pages is one, feeding the print media for a first page before generation of print data of the first page is completed, and, when the number of pages is two or more, feeding the print media for the first page in response to completion of generation of the print data of the first page.

### BRIEF DESCRIPTION OF THE DRAWINGS

FIG. 1 is a block diagram illustrating a configuration of a printing apparatus.

FIG. 2 is a simplified diagram schematically

illustrating a configuration of a print head and a transport unit.

FIG. 3 is a timing chart illustrating the case where the number of pages is one.

FIG. 4 is a timing chart illustrating the case where the number of pages is two.

FIG. 5 is a flowchart illustrating a printing process for a first page.

FIG. 6 is a flowchart illustrating a printing process for a second page.

### DESCRIPTION OF EMBODIMENTS

Embodiments of the present disclosure will now be described in the following order.

(1) Configuration of Printing Apparatus

(2) Timing Chart of Printing Process

(3) Printing Process

(4) Other Embodiments

### 1. Configuration of Printing Apparatus

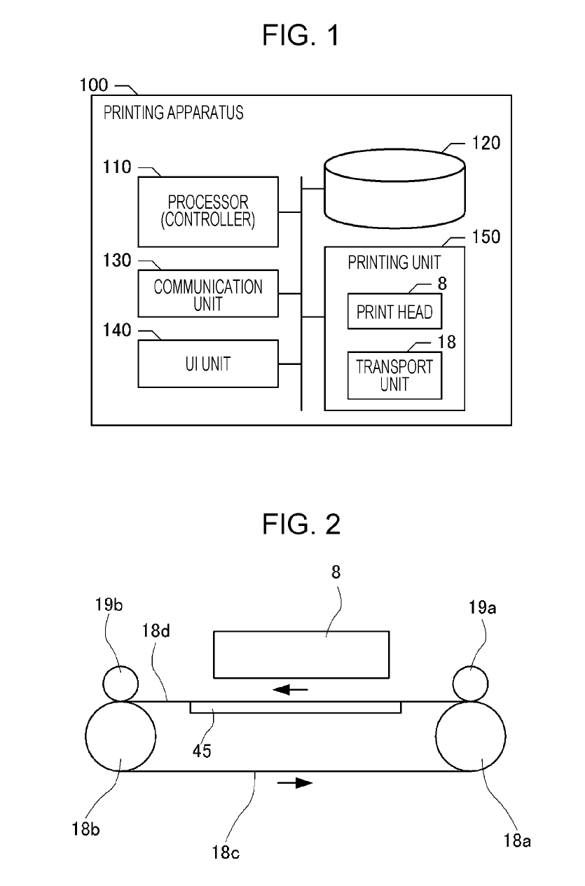

FIG. 1 is a block diagram illustrating a configuration of a printing apparatus 100 according to an embodiment of the present disclosure. The printing apparatus 100 includes a processor 110, which serves as a controller; a storage medium 120; a communication unit 130; a user interface (UI) unit 140; and a printing unit 150.

The processor 110 controls the printing apparatus 100, in which a central processing unit(CPU), random access memory (RAM), and read-only memory (ROM) (not illustrated) are included, by executing a program stored in the ROM or the storage medium 120. The processor 110 may be implemented as a single chip or as multiple chips. In the present embodiment, the processor 110 is a CPU, but it may alternatively be an application-specific integrated circuit (ASIC)or the like, or a combination of aCPU and an ASIC.

The storage medium 120 stores various programs, such as a control program for controlling printing, and printing data of a print job transmitted from a host device (not illustrated). The communication unit 130 includes a circuit used for communication with the host device in accordance with various wired or wireless communication protocols. The UI unit 140 includes a touch panel display, keys, and the like for displaying various kinds of information to a user and receiving user operations.

In the present embodiment, the printing unit 150 employs a line ink-jet method. The printing unit 150 includes a print head 8 and a transport unit 18. The transport unit 18 feeds print media at a given interval onto a transport belt and rotates the transport belt to transport the print media. The print head 8 ejects ink onto the print media on the transport belt. In the present embodiment, the print media are cut paper sheets.

FIG. 2 is a simplified diagram schematically illustrating a configuration of the print head 8 and the transport unit 18. The transport belt 18c, which is an endless belt, is wound around an upstream driving pulley 18a and a downstream driven pulley 18b, and is applied with a predetermined tension by a tensioner (not illustrated). The driving pulley 18a is rotationally driven by a motor (not illustrated) controlled by the processor 110. When the driving pulley 18a is rotationally driven, the transport belt 18c transports the print media adsorbed onto the transport belt 18c.

A support plate 45 is disposed inside the transport belt 18c such that the inward bending of the transport belt 18c is regulated by the support plate 45. A driven roller 19a is disposed on the upper side of the driving pulley 18a with the transport belt 18c interposed therebetween, and a driven roller 19b is disposed on the upper side of the driven pulley 18b with the transport belt 18c interposed therebetween. The print media transported by the transport belt 18c are pressed against the transport belt 18c by the driven rollers 19a and 19b. In the present embodiment, the print media are electrostatically attracted to the outer circumferential surface 18d of the transport belt 18c by a charge roller, a discharging brush, or the like (not illustrated).

Print media stored in a paper cassette (not illustrated) move along a paper-feed path by a transport mechanism (not illustrated), pass between the driving pulley 18a and the driven roller 19a, and are fed so that the leading edges of the print media reach a predetermined printing-start position. The printing-start position is a position determined in advance with reference to the position of the print head 8 in the transport direction of the print media. Picking up a print-media sheet from a paper cassette and transporting it until its leading edge reaches the printing-start position is referred to as sheet feeding.

The print head 8 that ejects ink is a so-called line head having a length covering the width of a print-media sheet in its width direction, that is, in the direction perpendicular to the transport direction of the sheet. The processor 110 executing a control program performs printing by feeding a print-media sheet, rotating the transport belt 18c, and ejecting ink based on print data while causing the print-media sheet to pass under the print head 8.

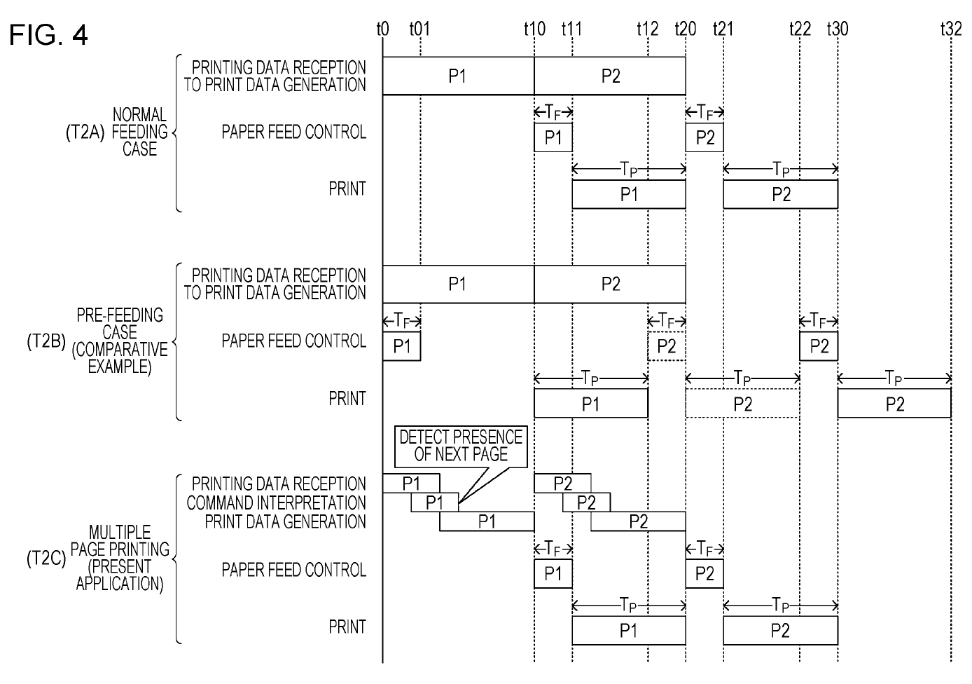

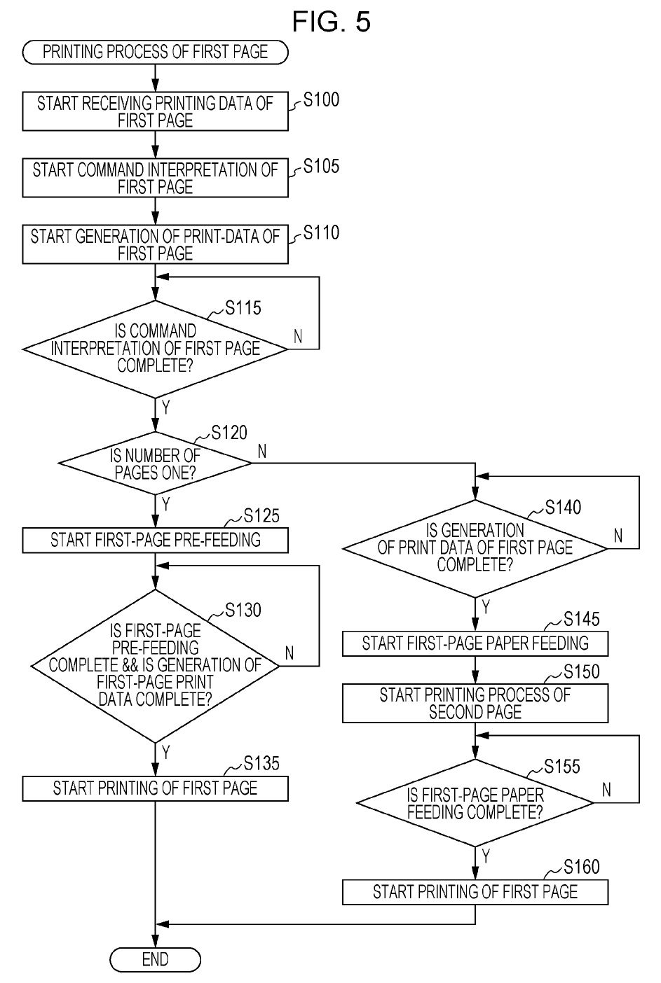

When ink-ejection control of a print-media sheet is started, the processor 110 controls the transport unit 18 so that the transport belt 18c continues to rotate until printing on the sheet is complete and the trailing edge of the sheet passes over the transport belt 18c. When a plurality of print-media sheets are continuously printed, for example, when a plurality of pages are included in one print job in the case of single-sided printing, the processor 110 controls the transport unit 18 such that the transport belt 18c continues to rotate until printing of the last page of the print job is completed after the start of printing of the first page on the first print-media sheet. In the printing apparatus 100, to prevent the printing control from becoming complicated, feeding of a first sheet, printing of the first sheet, feeding of a second sheet, printing of the second sheet, and so on are performed at predetermined intervals, as illustrated in chart T2A of FIG. 4.

### 2. Time Chart of Printing Process

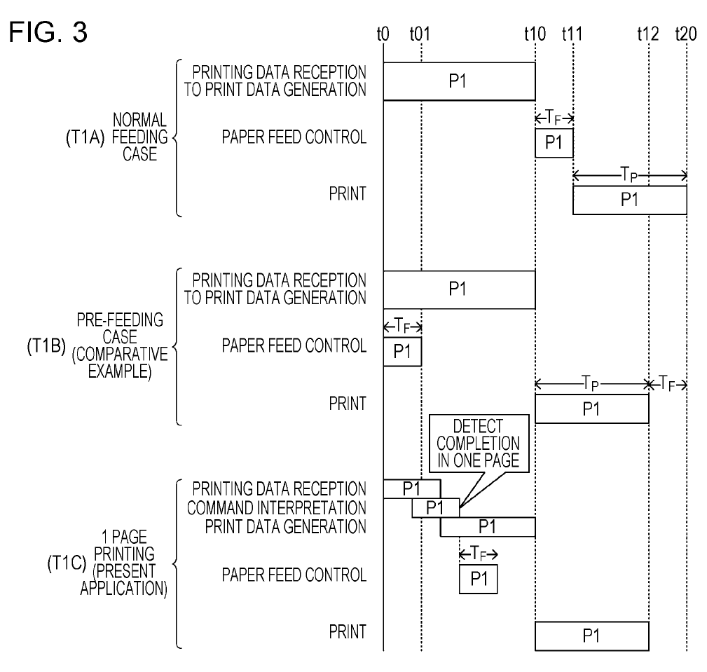

Next, a description is given of single-page printing and multiple-page printing in the case of single-sided printing. In single-sided printing, printing of a first page (P1) is performed on a first print-media sheet, and printing of a second page (P2) is performed on a second print-media sheet. FIG. 3 illustrates a timing chart for the case where only one page is included in the print job, and FIG. 4 illustrates a timing chart for the case where a plurality of pages (two pages as a specific example) are included in the print job.

The timing chart T1A in FIG. 3 illustrates an example in which a print-media sheet is fed in a normal mode when the number of pages is only one. Sheet feeding after completion of generation of print data is referred to as normal feeding in the present specification. At time t0, reception of the printing data of the first page is started, and print data of the first page is generated based on the printing data. When generation of the print data of the first page is completed at time t10, sheet feeding for the first page is performed, and when sheet feeding for the first page is completed at time t11, printing of the first page is started.

Even when the number of pages included in the print job is two or more, the chart for the normal feeding is similar to chart T1A in FIG. 3. Chart T2A in FIG. 4 illustrates a timing chart for normal feeding when two pages are included in the print job. That is, as in the case of chart T1A, reception of the printing data of the first page is started at time t0, and print data of the first page is generated based on the printing data. When generation of the print data of the first page is completed at time t10, sheet feeding for the first page is performed, and when the sheet feeding for the first page is completed at time t11, printing of the first page is performed. Printing of the first page is completed at time t20.

In addition, when generation of the print data of the first page is completed at time t10, reception of the printing data of the second page is started. If generation of the print data of the second page is completed before time t20, at which the printing of the first page is complete, sheet feeding for the second page is performed at time t20. When sheet feeding for the second page is completed at time t21, printing of the second page is performed. The printing apparatus 100 of the present embodiment operates such that once printing is started, the rotation speed of the transport belt 18c remains constant and is not stopped until completion of printing. However, after pre-feeding of the first page described later, the printing apparatus 100 temporarily stops rotation until printing of the first page is started.

Since the rotation speed of the transport belt 18c is constant, the printing time period T_{P} for one page is constant when the print-media sheets are of the same size. In addition, the sheet-feeding time T_{F} is also constant. As described above, in the printing apparatus 100, cycle control is performed such that printing on a print-media sheet is started after a time period T_{F} has elapsed since the start of the sheet feeding; the next print-media sheet is fed after a time period T_{P} has elapsed since completion of the previous printing; and printing on the next print-media sheet is started after the time period T_{F} has elapsed since completion of the sheet feeding. Therefore, when a plurality of pages are continuously printed, the print-media sheets are fed at a predetermined interval (T_{F} + T_{P}), and printing is also performed at the same predetermined interval.

When sheet feeding is started, printing is to be started after the time period T_{F}. Therefore, print-media sheets for the second and subsequent print target pages are fed when generation of the print data for the corresponding print-target page is complete. For example, if generation of the print data of the second page is not completed by time t20, which is the feeding timing of the print-media sheet for the second page, feeding of the print-media sheet for the second page is started at time t30, which is a predetermined time interval (T_{F} + T_{P}) later than time t20.

To reduce the total printing time, a pre-feeding method is known. In the present specification, the total printing time refers to a time period from the start of reception of printing data for one print job from the host device to completion of printing of all pages included in the print job. In addition, in the present specification, the term pre-feeding refers to feeding a print-media sheet for the first page before generation of the print data of the first page is completed.

Chart T1B in FIG. 3 is a timing chart for the case where the number of pages included in the print job is one and pre-feeding is performed immediately after reception of printing data of the first page is started. When reception of the printing data of the first page is started at time t0, print data of the first page is generated based on the printing data. Additionally, at time t0, feeding of a print-media sheet for printing the first page is started in advance. The processor 110 causes the transport belt 18c to rotate so that the leading edge of the print-media sheet on which the first page is to be printed reaches the printing-start position, and temporarily stops the rotation when the leading edge reaches the printing-start position. After the lapse of the time period T_{F,} sheet feeding is completed at time t01; however, printing remains in a standby state (the rotation of the transport belt 18c that was temporarily stopped has not yet been restarted) until generation of the print data of the first page is completed. When generation of the print data of the first page is completed at time t10, the transport belt 18c starts to rotate and printing based on the print data is started. When printing is started at time t10, it is completed at time t12 after the lapse of the time period T_{P}.

As illustrated in charts T1A and T1B, time t12, at which printing of the first page is completed in pre-feeding for the first page, is earlier by the time period T_{F} used for feeding than time t20, at which printing is completed when normal feeding is performed instead of pre-feeding. Accordingly, the total printing time from the start of print-data reception at time t0 to completion of printing of the first page in pre-feeding for the first page is shorter by the time period T_{F} than that in normal feeding, which is performed instead of pre-feeding. For this reason, when the number of pages included in the print job is only one, pre-feeding the first print-media sheet is advantageous.

In contrast, when the number of pages included in the print job is two or more, simply performing pre-feeding for the first page, as illustrated in chart T1B, instead results in a prolonged total printing time. Chart T2B in FIG. 4 is a timing chart for the case where the number of pages included in the print job is two and pre-feeding for the first page is simply performed. When reception of the printing data of the first page is started at time t0, the print data of the first page is generated based on the printing data. Additionally, at time t0, pre-feeding of the print media for the first page is started. Although the feeding is completed at time t01 after the time period T_{F}, printing is on standby until generation of print data of the first page is completed. Upon completion of generation of the print data of the first page at time t10, printing of the first page based on the print data is started. When printing of the first page is started at time t10, the printing is completed at time t12, which is the time period T_{P} later than time t10.

As described above, when a plurality of pages are continuously printed, sheet feeding and printing are performed at predetermined intervals. When printing of the first page is completed at time t12, sheet feeding for the second page starts at time t12; however, printing of the second page cannot start because generation of the print data of the second page has not yet been completed at time t12. If sheet feeding for the second page is started before generation of the print data of the second page is completed, there may be a case where, if the generation of the print data of the second page is not completed at the timing when the leading edge of the transported print-media sheet for the second page reaches the printing-start position, ink ejection based on the print data cannot be performed on the print-media sheet passing under the print head 8. In this case, printing of the second page results in a failure. Therefore, printing of the second and subsequent pages while the transport belt 18c is rotating is performed only after generation of the print data of each page is completed.

Accordingly, it is necessary to wait for sheet feeding for the second page until time t22, which is the predetermined time interval (T_{F} + T_{P}) later than time t12. As a result, printing of the second page is completed at time t32, which is the time period (T_{F} + T_{P}) later than time t22. As illustrated in charts T2A and T2B, time t32, at which printing of the second page is completed in the case of pre-feeding of the first page, is the time period T_{P} later than time t30, at which printing of the second page is completed in the case of normal feeding of the first page instead of pre-feeding. In other words, the total printing time from the start of print-data reception at time t0 to completion of printing of the second page is longer by the time period T_{P} in the case of pre-feeding of the first page than in the case of normal feeding of the first page instead of pre-feeding. For this reason, when the number of pages included in the print job is two or more, normal feeding of the first print-media sheet instead of pre-feeding it is advantageous.

Therefore, in the present embodiment, when the number of pages in one print job is one, the processor 110 feeds a print-media sheet for the first page before generation of the print data of the first page is completed (pre-feeding). When the number of pages is two or more, the processor 110 feeds the print-media sheet for the first page in response to completion of generation of the print data of the first page (normal feeding). That is, in the case of a plurality of pages, the processor 110 does not perform pre-feeding of the print-media sheet for the first page.

In the present embodiment, the processor 110 determines whether the number of pages included in the print job is only one by receiving printing data from the host device and interpreting a command included in the printing data.

When the processing contents from printing-data reception to print-data generation illustrated in charts T1A, T1B, T2A, and T2B are subdivided, as illustrated in charts T1C and T2C, they include printing-data reception, command interpretation, and print-data generation for generating print data from the printing data based on the interpreted command. More specifically, for example, when printing data is not represented by gray scales on an ink color basis, the process of generating the print data includes color conversion into the gray scales on an ink-color basis, halftone processing, and rearranging of the ejection order for each band.

Chart T1C in FIG. 3 is a timing chart in the present embodiment when the number of pages included in the print job is only one. When reception of the printing data starts at time t0, the printing data begins to be accumulated in the storage medium 120 of the printing apparatus 100. When a predetermined amount of data is accumulated, the processor 110 starts command-interpretation processing. When the number of pages included in the print job is only one, end-of-file (EOF) information indicating the end is included after the printing data for one page. If the presence of the EOF information at the end of the printing data is detected at a stage where printing data corresponding to one page is received or where command interpretation is completed, the processor 110 determines that the number of pages included in the print job is only one.

When determining that the number of pages included in the print job is only one, the processor 110 feeds a print-media sheet on which the first page is to be printed. That is, the processor 110 rotates the transport belt 18c so that the leading edge of the print-media sheet for printing the first page reaches the printing-start position, and temporarily stops the rotation of the transport belt 18c when the leading edge of the print-media sheet reaches the printing-start position. It is desirable that sheet feeding start such that the feeding is completed before generation of the print data of the first page is completed. Chart T1C illustrates an example in which sheet-feeding control is started in response to detection of the presence of the EOF information after command interpretation is completed, and the sheet feeding is completed before generation of the print data is completed.

When generation of the print data of the first page is completed at time t10, the processor 110 restarts rotation of the transport belt 18c to perform printing of the first page. Since the printing time is T_{P}, printing of the first page is completed at time t12, which is the time period T_{P} later than time t10. As described above, according to the present embodiment, as illustrated in charts T1A and T1C, in the case of printing only one page, the total printing time can be reduced by performing pre-feeding, as compared with the case where pre-feeding is not performed.

Chart T2C in FIG. 4 is a timing chart of printing in the present embodiment for the case where a print job includes a plurality of pages. As in the case of printing only one page, when reception of the printing data is started at time t0, the printing data begins to be accumulated in the storage medium 120 of the printing apparatus 100. When a predetermined amount of data is accumulated, the processor 110 starts command-interpretation processing. If the EOF information is absent at the end of the data at a stage where printing data corresponding to one page is received or where command interpretation is completed, the processor 110 determines that the number of pages included in the print job is two or more.

When it is determined that the number of pages included in the print job is two or more, the processor 110 does not perform pre-feeding for the first page, and starts sheet feeding for the first page after generation of the print data of the first page is completed. Therefore, sheet feeding for the first page starts at time t10, at which generation of the print data of the first page is completed. The subsequent steps are the same as those illustrated in chart T2A of FIG. 4. Accordingly, as illustrated in charts T2B and T2C, the total printing time from reception of the printing data to completion of printing of the second page is shorter in the case where pre-feeding is not performed, as in the present embodiment (refer to T2C), than in the case where pre-feeding is performed (refer to T2B). As described above, according to the present embodiment, in the case where the number of pages included in the print job is two or more, normal feeding instead of pre-feeding is performed for the first page, thereby enabling reduction of the total printing time as compared with the case where pre-feeding is performed for the first page.

As described above, according to the present embodiment, the total printing time can be prevented from being unnecessarily prolonged in the case of printing a plurality of pages, and the total printing time can be shortened by performing pre-feeding in the case of printing a single page.

When the EOF information is present at the end of the data of the second page at a stage where the printing data of the second page is received and command interpretation is completed, the processor 110 determines that the number of pages included in the print job is two, and does not perform processing for the third and subsequent pages (the same processing as that for the second page).

### 3. Printing Process

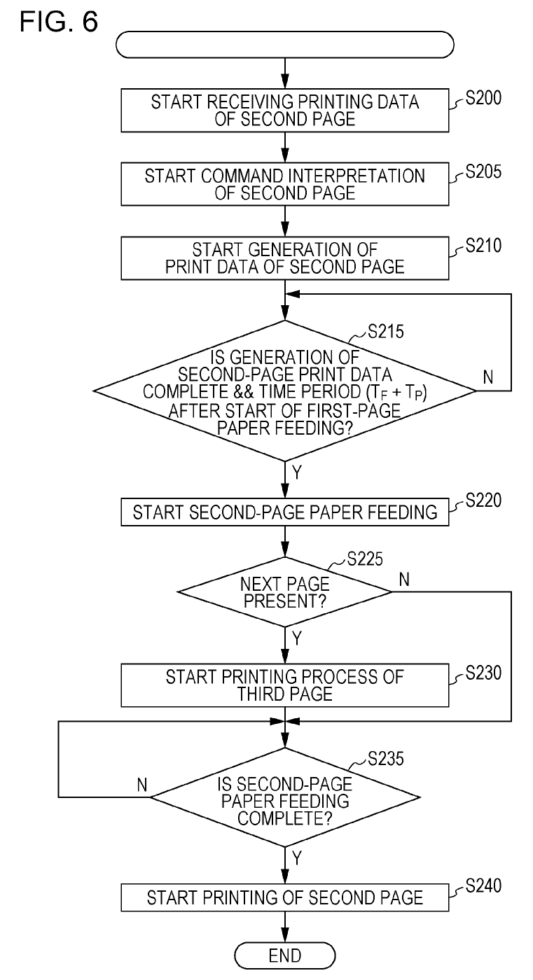

Next, a printing process executed by the processor 110 will be described with reference to the flowcharts of FIGS. 5 and 6. FIG. 5 is a flowchart illustrating a printing process for the first page. The printing process in FIG. 5 is started when printing data is newly received from the host device. The processor 110 starts receiving the printing data for the first page (step S100). When a predetermined amount of data is accumulated, the processor 110 starts command interpretation of the first page (step S105). Subsequently, the processor 110 starts generating print data of the first page (step S110).

Subsequently, the processor 110 waits until command interpretation of the first page is complete (step S115) and determines whether the number of pages is one (step S120). That is, the processor 110 determines that the number of pages is only one if end-of-file (EOF) information is present at the end of the printing data of the first page, and determines that the number of pages is two or more if the EOF information is absent.

In step S120, when it is determined that the number of pages is one, the processor 110 starts pre-feeding for the first page (step S125). That is, the processor 110 controls the transport unit 18 to pick up the first print-media sheet for printing the first page from the paper cassette and to transport the first print-media sheet until the leading edge of the first print-media sheet reaches a predetermined printing-start position.

Subsequently, the processor 110 waits until pre-feeding of the first page and generation of the print data of the first page are complete (step S130) and starts printing of the first page if both are complete (step S135). That is, the processor 110 causes the transport unit 18 to start rotation of the transport belt 18c and causes the print head 8 to eject ink based on the print data of the first page. Once printing of the first page is completed, the processor 110 controls a paper-discharge mechanism (not illustrated) to move the print-media sheet for the first page along the paper-discharge transport path and to discharge the print-media sheet to a discharge tray.

If it is not determined that the number of pages is one in step S120, the processor 110 waits until generation of the print data of the first page is complete (step S140) and, when the generation is complete, starts sheet feeding for the first page (step S145). That is, the processor 110 performs normal feeding of the first page. Subsequently, the processor 110 starts the printing process for the second page (step S150). The printing process for the second page will be described later with reference to FIG. 6.

In parallel with the processing of step S150 (refer to FIG. 6), the processor 110 waits until sheet feeding for the first page is completed (step S155) and starts printing of the first page when the feeding is complete (step S160). That is, the processor 110 causes the transport unit 18 to start rotation of the transport belt 18c, and causes the print head 8 to eject ink based on the print data of the first page.

FIG. 6 is a flowchart illustrating a printing process for the second page. The printing process for the second page illustrated in FIG. 6 starts in step S150 of FIG. 5. Once the printing process for the second page starts, the processor 110 starts receiving the printing data for the second page (step S200). If the storage medium 120 has a free space for storing printing data, reception and accumulation may be started prior to the start of the processing illustrated in FIG. 6. Subsequently, the processor 110 starts command interpretation of the second page (step S205). Subsequently, the processor 110 starts generating print data of the second page (step S210).

Subsequently, the processor 110 waits until generation of the print data of the second page is complete and a predetermined time interval (T_{F} + T_{P} ) has elapsed from the start of sheet feeding for the first page (step S215), and starts sheet feeding for the second page when both conditions are satisfied (step S220). That is, normal feeding is performed for the second page.

Subsequently, the processor 110 determines whether there is a next page (step S225). That is, when the EOF information is absent at the end of the printing data of the second page, the processor 110 determines that the next page is present.

If it is determined in step S225 that the next page is present, the processor 110 starts the printing process for the third page (step S230). The printing process for the third page will be described later. Subsequently, the processor 110 waits until sheet feeding for the second page is complete (step S235), and starts printing of the second page when the sheet feeding is complete (step S240). That is, the processor 110 continues rotating the transport belt 18c and causes the print head 8 to eject ink based on the print data of the second page.

The printing process for the third page starting in step S230 is a process in which the descriptions of "second page" and "third page" in the printing process for the second page illustrated in FIG. 6 are replaced with "third page" and "fourth page", respectively. The same applies to the printing process for the subsequent pages.

### 4. Other Embodiments

The above embodiment is merely an example of implementing the present disclosure, and various other embodiments may also be adopted. For example, as the printing method of the printing apparatus, the line ink-jet method described in the above embodiment may be adopted. Alternatively, a configuration in which a print head is mounted on a carriage that reciprocates in the main-scanning direction and printing is performed by a serial ink jet method may be adopted, or other printing methods may be employed.

A printer-driver program installed in the host device may be configured such that information indicating the number of pages included in the print job is included in the printing data transmitted from the host device. In this case, the controller may be configured to determine whether the number of pages included in the print job is only one based on the information on the number of pages received from the host device.

Each process for generating the printing data differs depending on the format of the print data transmitted from the host device. Therefore, the print-data generation process described in the above embodiment is exemplary, and other processes may be included, or any of the processes described in the above embodiment may be omitted.

In a case where the number of pages included in a print job is one and the number of print copies is two or more, a configuration in which normal feeding instead of pre-feeding is performed for the first page may be adopted.

Furthermore, the present disclosure is also applicable as a program executed by a computer or as a printing method. For example, the printing method is executed by a controller of a printing apparatus that includes a transport unit configured to transport print media by feeding the print media at a given interval onto a transport belt and rotating the transport belt; a print head configured to eject ink onto the print media on the transport belt; and the controller configured to control the print head and the transport unit based on one or more print jobs to perform printing on the print media. The printing method includes, for one of the one or more print jobs, when the number of pages is one, feeding the print media for a first page before generation of the print data of the first page is completed, and, when the number of pages is two or more, feeding the print media for the first page in response to completion of generation of the print data of the first page.

In addition, a system, a program, and a method as described above may be implemented as a single device or by using components included in a plurality of devices, and various implementation forms are encompassed. The configuration may also be modified such that the configuration is implemented by a combination of software and hardware. Furthermore, the present disclosure may also be implemented as a recording medium that stores a program for controlling the system. The recording medium for the program may be a magnetic recording medium or a semiconductor memory, and any recording medium developed in the future is considered to fall within the same scope.

What is claimed is:

1. A printing apparatus comprising:
a transport unit configured to transport print media by feeding the print media at a given interval onto a transport belt and rotating the transport belt;
a print head configured to eject ink onto the print media on the transport belt; and
a controller configured to control the print head and the transport unit based on one or more print jobs to perform printing on the print media,
wherein the controller is configured to, for one of the one or more print jobs,
when a number of pages is one, feed the print media for a first page before generation of print data of the first page is completed, and
when the number of pages is two or more, feed the print media for the first page in response to completion of generation of the print data of the first page.

2. The printing apparatus according to claim 1, wherein the controller is configured to, when detecting that, in the print job, printing data of second and subsequent pages is absent after printing data of the first page, determine that the number of pages of the print job is one.

3. The printing apparatus according to claim 1, wherein the controller is configured to acquire information indicating the number of pages of the print job set by a printer driver of a host device, and to determine, based on the information, whether the number of pages of the print job is one.

4. A printing method executed by a controller of a printing apparatus, the printing apparatus including
a transport unit configured to transport print media by feeding the print media at a given interval onto a transport belt and rotating the transport belt,
a print head configured to eject ink onto the print media on the transport belt, and
the controller configured to control the print head and the transport unit based on one or more print jobs to perform printing on the print media,
the printing method comprising, for one of the one or more print jobs,
when a number of pages is one, feeding the print media for a first page before generation of print data of the first page is completed, and
when the number of pages is two or more, feeding the print media for the first page in response to completion of generation of the print data of the first page.
